(19) United States
(12) Patent Application Publication
(10) Pub. No.: US 2026/0351886 A1
(43) Pub. Date: Nov. 5, 2026

(54) CONTACT ARRANGEMENT WITH INSERTION BEHAVIOR INDEPENDENT OF INSERTION DIRECTION AND KIT

(71) Applicant: TE Connectivity Solutions GmbH, Schaffhausen (CH)

(72) Inventors: Jochen FERTIG, Schaffhausen (CH); Martin BLEICHER, Schaffhausen (CH); Michael BURGHARD, Schaffhausen (CH); Stefan MASAK, Schaffhausen (CH); Andre MAIROSER, Schaffhausen (CH); Ryan HETRICK, Schaffhausen (CH); Stefan BRAUN, Schaffhausen (CH); Jochen BRANDT, Schaffhausen (CH); Andreas MERKLE, Schaffhausen (CH); Steffen SCHOELLHAMMER, Schaffhausen (CH); Claire MAGNE, Schaffhausen (CH); Alberto ALAMO ALONSO, Schaffhausen (CH); Georg HOCHBAUER, Schaffhausen (CH); Fabian LANDGRAF, Schaffhausen (CH)

(21) Appl. No.: 19/660,609

(22) Filed: Apr. 28, 2026

(30) Foreign Application Priority Data
Apr. 30, 2025 (DE) 102025116823

(51) Int. Cl. H01R 13/426; H01R 43/20

(52) U.S. Cl. CPC H01R 13/426; H01R 43/20

(57) ABSTRACT

A contact arrangement into which at least one plug contact can be inserted in at least two insertion directions includes a receptacle into which the plug contact can be inserted along a first insertion direction and along a second insertion direction. The first insertion direction and the second insertion direction enclose an opening angle. A pressure spring arrangement is arranged at least in part in the receptacle and comprising at least one pressure spring element and is configured to press the plug contact in a direction perpendicular to the first and second insertion directions. Each pressure spring element extends with a deviation of at most 15° along or perpendicular to the angle bisector of the opening angle. A plug contact with at least similar insertion behavior can be inserted into such a contact arrangement from different directions.

This application claims the benefit of DE Application No. 102025116823 filed 30-April-2025, the subject matter of which is herein incorporated by reference in its entirety.

### BACKGROUND OF THE INVENTION

The subject matter herein relates to a contact arrangement and a kit comprising such a contact arrangement.

Contact arrangements are known. They are typically used to electrically connect a plug that can be inserted into a receptacle of the contact arrangement with other contact elements. These contact arrangements often comprise a spring arrangement that is intended to provide the necessary contact force. A problem with known contact arrangements is that the plug contact can often be inserted only in a single direction, or that the insertion behavior varies significantly depending on the insertion direction. This insertion behavior is particularly influenced by the insertion resistance that the spring arrangement exerts against the plug contact during insertion.

There is a need to provide a contact arrangement into which a plug contact can be inserted from different directions with at least similar insertion behavior.

### BRIEF DESCRIPTION OF THE INVENTION

In one embodiment, a contact arrangement is provided into which at least one plug contact, such as a flat contact, can be inserted in at least two insertion directions. The contact arrangement includes a receptacle into which the at least one plug contact can be inserted in a first insertion direction and in a second insertion direction, wherein the first insertion direction and the second insertion direction enclose an opening angle. The contact arrangement includes a pressure spring arrangement arranged at least in part in the receptacle, comprising at least one pressure spring element. The pressure spring arrangement is configured to press the at least one plug contact in a direction perpendicular to the first and second insertion directions. Each pressure spring element extends with a deviation of at most 15° along or perpendicular to the angle bisector of the opening angle.

The orientation of the pressure spring elements with respect to the angle bisector between the first and second insertion directions ensures that the insertion resistances that the plug contact must overcome during insertion, and thus the insertion behavior along both insertion directions, are at least similar.

Embodiments can be further improved by the following features, each of which is advantageous in itself and can be combined with each other as desired.

Preferably, the longitudinal direction of each pressure spring element extends with a deviation of at most 15° along or perpendicular to the angle bisector of the opening angle. This means that each pressure spring element, in particular the longitudinal direction of each pressure spring element, deviates by at most ±15° from the angle bisector or a line perpendicular to the angle bisector. The perpendicular line preferably lies within or parallel to a plane spanned by the first and second insertion directions.

The longitudinal directions of the pressure spring elements may be understood to refer to the longitudinal directions of the projections of the pressure spring elements onto the plane spanned by the first and second insertion directions.

The pressure spring elements are preferably configured to be deflectable in a direction perpendicular to the first and second insertion directions.

For the sake of brevity, the term “the at least one plug contact” may be replaced in the following by “the plug contact” or “a plug contact.”

According to a preferred configuration, the opening angle can range from 0° to 180°. This configuration can be flexibly adapted to various applications and mounting conditions, as the plug contact can be inserted into the receptacle over a wide range of angles. More preferably, the opening angle can range from 60° to 120°, and yet more preferably, it can be 90°.

According to another configuration, the plug contact can be inserted into the receptacle along a third insertion direction opposite to the first insertion direction and along a fourth insertion direction opposite to the second insertion direction. In this configuration, the plug contact can be inserted into the receptacle along its entire circumference, so that the flexibility with regard to the applications and mounting conditions of the contact arrangement is even greater.

To align the insertion behavior of the plug contact along the insertion directions, at least one pressure spring element, preferably, however, each pressure spring element of the pressure spring arrangement, may be symmetrical with respect to a plane of symmetry spanned by the angle bisector of the opening angle and a normal to the first and second insertion directions.

In order to reliably hold the plug contact in the receptacle and establish electrical contact, the contact arrangement may, according to a further aspect, comprise a contact spring arrangement comprising at least one contact spring element, which contact spring arrangement counteracts the pressure spring arrangement and is arranged at least in part within the receptacle. Preferably, the contact spring arrangement protrudes into the receptacle. The contact spring elements are preferably configured to be deflectable in a direction perpendicular to the first and second insertion directions.

The contact spring arrangement is preferably an electrical, in particular an electrically conductive, spring arrangement. For example, the contact spring arrangement may be made of a copper alloy.

According to a preferred configuration, each contact spring element, in particular a longitudinal direction of each contact spring element of the contact spring arrangement, may extend with a deviation of at most 15° along or perpendicular to the angle bisector of the opening angle. Analogous to the pressure spring arrangement, in this configuration, the insertion behavior, in particular the insertion resistance of the plug contact during insertion along the first and second insertion directions, is aligned.

To simplify the design and manufacture of the contact arrangement and thereby reduce costs, the pressure spring arrangement and the contact spring arrangement may be configured identically. An identical configuration also has the advantage that the pressure spring arrangement and the contact spring arrangement exert the same forces on the plug contact inserted into the contact arrangement, at least in a direction perpendicular to the first and second insertion directions, thereby ensuring that the plug contact is held in a centered position within the receptacle.

In a particularly preferred configuration, the pressure spring arrangement and/or the contact spring arrangement may be a lamellar spring. In this case, the pressure spring elements or contact spring elements may each correspond to a lamella of the lamellar spring. Due to the parallel arrangement of the lamellas of the lamellar spring, it is easy to align all the pressure spring elements of the pressure spring arrangement perpendicular to the angle bisector or along the angle bisector, which facilitates the insertion of a plug contact into the receptacle. Furthermore, lamellar springs are cost-effective and offer the possibility of being easily formed monolithically with other elements of the contact arrangement.

According to other aspects, the pressure spring arrangement and/or the contact spring arrangement may be a leaf spring, a flat spring, and/or a parabolic spring. In particular, in the case of a parabolic spring, each pressure spring element of the pressure spring arrangement may be parabolic in shape, wherein a vertex of each parabolic pressure spring element may be the point of the pressure spring element that protrudes furthest into the receptacle. Of course, at least one pressure spring element of the pressure spring arrangement may also be curved in a shape other than parabolic.

According to another configuration, the contact arrangement may comprise an upper contact plate and a lower contact plate opposite the upper contact plate. The pressure spring arrangement may be arranged on or formed by the upper contact plate and/or the contact spring arrangement may be arranged on or formed by the lower contact plate. The upper and lower contact plates provide stability to the contact arrangements and allow the pressure spring arrangement or the contact spring arrangement to be supported by one of the respective contact plates.

The term “contact plate” does not necessarily mean that the contact plates must or are capable of establishing an electrical contact, for example with a plug contact.

Preferably, the pressure spring arrangement is configured to press the plug contact held in the receptacle toward the lower contact plate, in particular against the lower contact plate and/or the contact spring arrangement.

A configuration that is easy to manufacture and, in particular, saves space when using flat contacts as plug contacts is achieved when the contact arrangement is essentially cuboid in shape or configured as a cuboid. The lower contact plate preferably corresponds to the base area of the cuboid, and the upper contact plate to its top surface.

The upper and lower contact plates may form part of a contact cage that encloses or forms the receptacle, at least in part. For this purpose, the upper and lower contact plates may be connected by struts extending, in particular, perpendicular to the upper and lower contact plates. The contact cage may be a self-supporting structure. In a cost-effective configuration, the contact cage is preferably monolithic, in particular configured as a stamped and bent part. Preferably, the contact cage has the shape of a cuboid, wherein, as mentioned above, the lower contact plate preferably corresponds to the base area of the cuboid and the upper contact plate to its top surface. On at least one of the side surfaces, the particularly cuboid-shaped contact cage may have an insertion opening leading into the receptacle, through which the plug contact can be inserted into the receptacle along the first, second, third, or fourth insertion direction.

In order to design the contact arrangement, in particular the lower and/or upper contact plate, to be stable, the lower contact plate and/or the upper contact plate may comprise an inner sub-plate and an outer sub-plate that abuts the inner sub-plate. An inner sub-plate may be understood to be the sub-plate facing the receptacle, and an outer sub-plate may be understood to be the sub-plate facing away from the receptacle.

According to another configuration, the pressure spring arrangement may be formed by or arranged on the inner or outer sub-plate of the upper contact plate, and/or the contact spring arrangement may be formed by or arranged on the inner or outer sub-plate of the lower contact plate. These configurations offer several advantages. For example, by being formed by or arranged on only one of the sub-plates, the contact spring arrangement or the pressure spring arrangement can be configured to be slimmer and thus more material-efficient. Furthermore, the spring arrangements are not subjected to any stress, particularly shear stress that may arise as a result of intentional or unintentional displacement of the sub-plates relative to one another.

The lower and/or upper contact plate may thus be configured as a two-layer structure; however, in other configurations, it may also be configured as a multi-layer structure, for example, a three-layer or four-layer structure, to make the contact arrangement even more dimensionally stable.

In a stable and at the same time cost-effective configuration, the pressure spring arrangement may be formed monolithically with the upper contact plate, in particular with the inner sub-plate of the upper contact plate. Analogously, the contact spring arrangement may be formed monolithically with the lower contact plate, in particular with the inner sub-plate of the lower contact plate.

In a configuration that is particularly well suited for automated manufacturing, both contact plates and both spring arrangements can together form a monolithic component, in particular the contact cage. The monolithic component or contact cage may be configured as a stamped and bent part.

In order to be able to provide sufficient pressing force, the pressure spring arrangement is preferably made of spring steel. The contact spring arrangement is preferably made of a copper alloy to allow high electrical conductivity and thus good contact between the contact spring elements of the contact spring arrangement and a plug contact received in the receptacle. In the configuration described above, in which the contact plates and spring arrangements together form a monolithic component, this monolithic component may be made of a resilient copper alloy. This ensures both that the pressure spring arrangement provides sufficient pressing force and that the contact spring arrangement exhibits high electrical conductivity.

According to another configuration, at least one end of at least one pressure spring element of the pressure spring arrangement may be displaceable along the outer sub-plate of the upper contact plate. In this way, the at least one end can slide along the outer sub-plate when under stress, in particular during insertion of the plug contact. This prevents overstressing of the pressure spring element and makes the insertion process more uniform. The at least one end is preferably displaceable along a side of the outer sub-plate facing the receptacle. The at least one displaceable end may be a free end.

The displaceable end of the at least one pressure spring element may be guided. For this purpose, guide grooves may be arranged on the outer sub-plate, for example, which are configured to be particularly complementary to the free end or ends. To limit the displaceability of the at least one displaceable end, a stop may be provided, which is preferably formed by the inner sub-plate, for example by an edge of the inner sub-plate.

According to another configuration, the lower and/or upper contact plate(s) may be formed, at least in part, by a contact body that is removably received in the receptacle. This configuration allows for easy assembly and disassembly of the contact arrangement. In addition, such a contact arrangement is flexible in use, as it can be adapted to various requirements, such as different mounting conditions or different types of plug contacts, by adapting the upper and/or lower contact plate.

Preferably, the inner sub-plate of the lower contact plate is formed by the contact body, since in this configuration the contact body can be contacted in a particularly easy manner by a plug contact received in the receptacle.

To make assembly and disassembly user-friendly and/or to prevent the contact body from shifting during operation, which would in particular endanger the contact, the contact arrangement may comprise a fastening and/or guide device that is configured to guide the contact body during insertion into and removal from the receptacle, and/or to secure the contact body in the receptacle, in particular to interlock it.

The fastening and/or guide device is preferably arranged on the lower contact plate, in particular on the outer sub-plate of the lower contact plate, or is formed monolithically with it.

The fastening and/or guide device may, for example, comprise jaws, brackets, arms, claws, or interlocking hooks that can be positioned on the edges of the contact body. The contact body can be secured particularly firmly in the receptacle if the jaws, brackets, arms, claws, or interlocking hooks engage positively in recesses, such as grooves in the contact body.

The plug contact and the contact body are preferably configured as flat contacts.

The problem is further solved by a kit comprising a contact arrangement according to one of the configurations described above and at least one contact body that can be inserted into the receptacle. The contact body may, for example, be configured according to one of the configurations described above.

### BRIEF DESCRIPTION OF THE DRAWINGS

FIG. 1 is a schematic perspective view of a contact arrangement according to a first embodiment.

FIG. 2 is a schematic perspective view of the contact arrangement from FIG. 1, with the plug contact inserted.

FIG. 3 is a schematic top view of the contact arrangement from FIG. 1.

FIG. 4 is a schematic cross-sectional view of the contact arrangement from FIG. 1.

FIG. 5 is a further schematic cross-sectional view of the contact arrangement with a plug contact from FIG. 2.

FIG. 6 is a schematic perspective view of a contact arrangement according to another possible embodiment.

FIG. 7 is a schematic perspective view of the contact arrangement from FIG. 6, with the plug contact inserted.

FIG. 8 is a schematic cross-sectional view of the contact arrangement from FIG. 6.

### DETAILED DESCRIPTION OF THE INVENTION

The invention is described in more detail below by means of embodiments with reference to the accompanying Figures. Individual features present in the following embodiment may be omitted if, in accordance with the above embodiments, the technical effect associated with that feature is not relevant. Conversely, a feature described above but not present in a subsequent embodiment may be added to the embodiment if the technical effect associated with that feature is deemed relevant for a particular application.

In the following, the same reference signs are used for elements that correspond to one another in terms of structure and/or function.

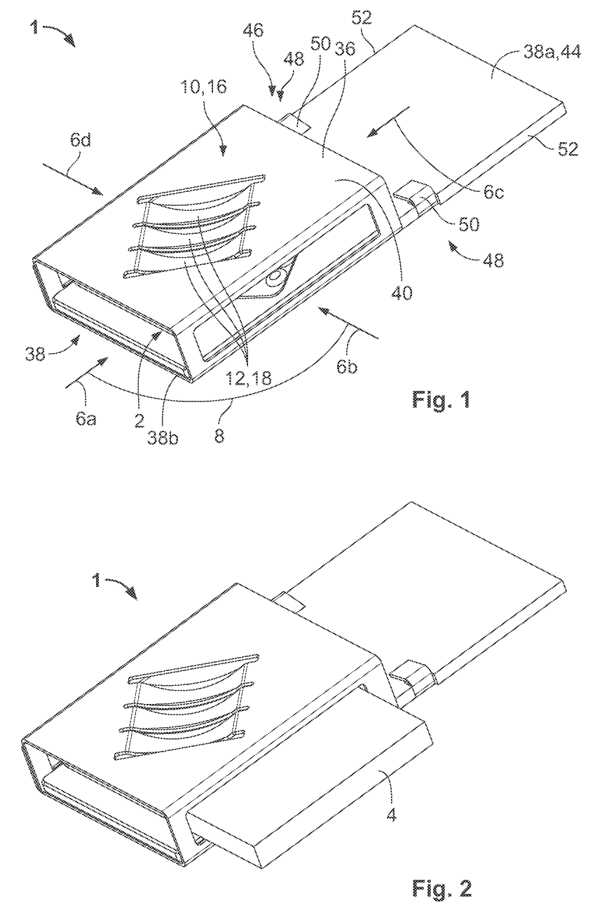

In the following, a first configuration of the contact arrangement is described purely by way of example with reference to FIGS. 1 to 5.

The contact arrangement 1 comprises a receptacle 2 into which at least one plug contact 4, preferably configured as a flat contact, can be inserted. The plug contact 4 can be inserted into the receptacle 2 along a first insertion direction 6a and along a second insertion direction 6b, wherein an opening angle 8 between the first and second insertion directions 6a, 6b is, purely by way of example, 90° in the present embodiment. In other configurations, the opening angle 8 may also differ from 90° and, for example, be between 0° and 180°, more preferably between 60° and 120°.

The contact arrangement 1 further comprises a pressure spring arrangement 10, which includes at least one pressure spring element 12. The pressure spring arrangement 10 is configured to press the at least one plug contact 4 (see FIG. 2), when it is inserted into the receptacle 2, in a direction perpendicular to, in particular in the direction of a normal 14 to the first and second insertion directions 6a, 6b. In the present embodiment, the pressure spring arrangement 10 may, for example, be configured as a lamellar spring 16, wherein the pressure spring elements 12 correspond to lamellas 18 of the lamellar spring 16. In the present embodiment, the lamellar spring 16 has, purely by way of example, three lamellas 18 extending parallel to one another.

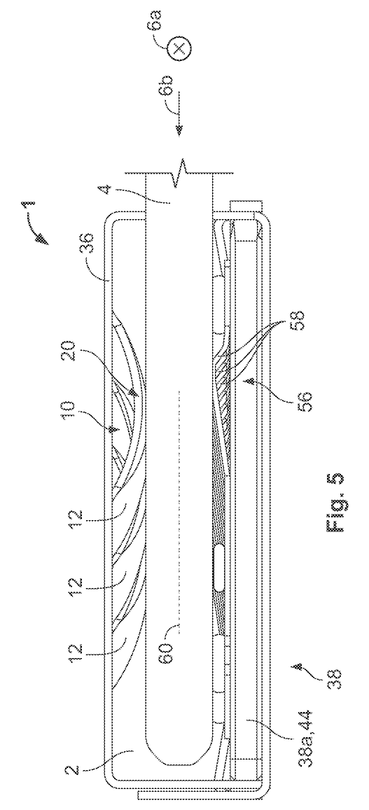

The pressure spring elements 12 may have a parabolic shape, wherein the vertices 20 of the pressure spring elements 12 may be the points of the pressure spring elements 12 that protrude furthest into the receptacle 2. In particular, the pressure spring elements 12 may abut the plug contact 4 inserted into the receptacle 2 in the region of their vertices 20, as can be clearly seen in FIG. 5.

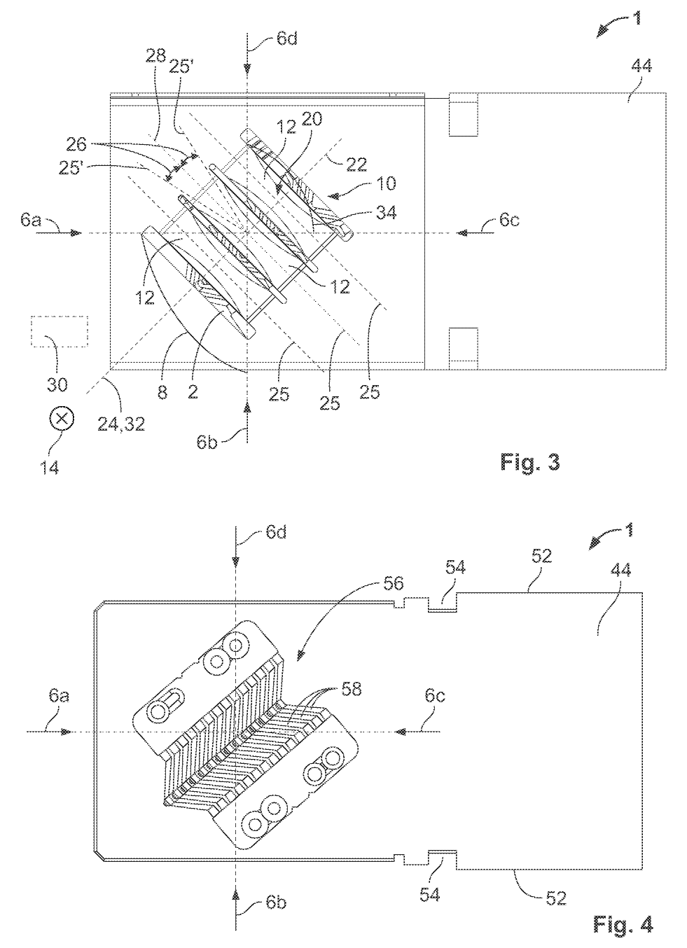

In the present embodiment, all pressure spring elements 12 of the pressure spring arrangement 10 may be symmetrical with respect to a plane of symmetry 22 spanned by the angle bisector 24 of the opening angle 8 and the normal 14 to the first and second insertion directions 6a, 6b. In particular, the plane of symmetry 22 may pass through the vertices 20 of all pressure spring elements 12. Of course, in other configurations, however, at least one pressure spring element 12 of the pressure spring arrangement 10 may alternatively be asymmetrical. For example, the vertices 20 of the pressure spring elements 12 may be arranged alternately with respect to the plane of symmetry 22. The plane of symmetry 22 is shown in FIG. 3 and extends into the image plane.

In the present embodiment, each pressure spring element 12, in particular a longitudinal direction 25 of each pressure spring element 12, extends, purely by way of example, perpendicular to the angle bisector 24 of the opening angle 8. In other configurations, however, each pressure spring element 12 may also extend along the angle bisector 24 of the opening angle 8. The pressure spring elements 12 do not necessarily have to extend exactly along the angle bisector 24 of the opening angle 8 or exactly perpendicular to the angle bisector 24 of the opening angle 8; but a deviation 26 of at most 15° from the angle bisector 24 or from a perpendicular 28 to the angle bisector 24 is tolerated. The perpendicular 28 lies preferably in a plane 30 spanned by the first and second insertion directions 6, 6b.

To illustrate the deviation 26, the longitudinal directions 25′ of the pressure spring elements 12 are indicated purely schematically in FIG. 3 with dashed lines, each of which would just barely have the permissible deviation 26 of at most 15° from the perpendicular 28. The previously described arrangements of the pressure spring elements 12 with respect to the first and second insertion directions 6a, 6b ensure that the insertion behavior, in particular the insertion resistance of the at least one plug contact 4 along both insertion directions 6a, 6b, is at least similar.

In the present embodiment, the at least one plug contact 4 may also be inserted into the receptacle 2 along a third insertion direction 6c, which is opposite to the first insertion direction 6a, and along a fourth insertion direction 6d, which is opposite to the second insertion direction 6b. In this configuration, the longitudinal directions 25 of the pressure spring elements 12 may extend perpendicular to the angle bisector 32 of a further opening angle 34 between the third and fourth insertion directions 6c, 6d. Of course, a course of the longitudinal directions 25 of the pressure spring elements 12 that deviates by at most 15° from the perpendicular 28 to the angle bisector 32 of the further opening angle 34 could also be tolerated here.

In the present embodiment, the contact arrangement 1 may, for example, be essentially cuboid in shape and comprise an upper contact plate 36 and a lower contact plate 38 opposite the upper contact plate 36. In the described embodiment, the upper contact plate 36 is, purely by way of example, made from a single-layer sheet of metal, with which the pressure spring arrangement 10 can be monolithically formed. In particular, the pressure spring arrangement 10 can be punched out of the single-layer sheet of metal and bent.

The lower contact plate 38 may comprise an inner sub-plate 38a facing the receptacle 2 and an outer sub-plate 38b facing away from the receptacle 2. The outer sub-plate 38b of the lower contact plate 38 may also be made of sheet metal. In the present embodiment, the upper contact plate 36, the outer sub-plate 38b of the lower contact plate 38, and the pressure spring arrangement 10 may be formed monolithically and, in particular, form a cuboid-shaped contact cage 40 surrounding the receptacle 2. The contact cage 40 may comprise webs 42 extending perpendicularly between the upper contact plate 36 and, in particular, the outer sub-plate 38b of the lower contact plate 38 and connecting them, such that the contact cage 40 is a self-supporting component.

The inner sub-plate 38a of the lower contact plate 38 may, for example, be formed by a contact body 44, which is preferably also configured as a flat contact. The contact body 44 may be arranged at least in part within the receptacle 2, wherein the contact body 44 can preferably be removed from and inserted into the receptacle 2. The contact arrangement 1 and the contact body 44, which can be inserted into the receptacle 2, may together form a kit 46.

To guide the contact body 44 during insertion into the receptacle 2 or removal from the receptacle 2, and/or to secure the contact body 44 in the receptacle 2, the contact arrangement 1 may comprise a fastening and/or guide device 48. In the present embodiment, the fastening and/or guide device 48 comprises, by way of example, claws 50 formed monolithically with the outer sub-plate 38b of the lower contact plate 38, which can be placed on edges 52 of the contact body 44. During insertion, the contact body 44 is guided in the claws 50 until they engage in grooves 54 (see FIG. 4) arranged on the edges 52 of the contact body 44, so that the contact body 44 is interlocked.

As can be seen particularly clearly from FIGS. 4 and 5, the contact arrangement 1 may further comprise a contact spring arrangement 56 that counteracts the pressure spring arrangement 10, which comprises at least one contact spring element 58. In the present embodiment, the contact spring arrangement 56 is, by way of example, arranged on the lower contact plate 38, in particular on the contact body 44 forming the inner sub-plate 38aof the lower contact plate 38.

The contact spring arrangement 56 is preferably an electrical spring, in particular an electrically conductive spring, intended to establish the best possible electrical contact with the plug contact 4 inserted into the receptacle 2. In principle, there are virtually no limits to the configuration of the contact spring arrangement 56. For example, the contact spring arrangement 56 and the pressure spring arrangement 10 may be identical, in particular both may be configured as lamellar springs 16. Alternatively or cumulatively, the contact spring arrangement 56 and the pressure spring arrangement 10 may be symmetrically opposed to one another with respect to a plane 60 extending between the contact spring arrangement 56 and the pressure spring arrangement 10 and along the first and second insertion directions 6a, 6b.

In the cross-sectional view from FIG. 5, the mode of operation of the contact arrangement 1 is clearly visible when the plug contact 4 is received in the receptacle 2. When the plug contact 4 – here, purely by way of example, along the second insertion direction 6b – is inserted into the receptacle 2, the compressed pressure spring elements 12 press the plug contact 4 in a direction perpendicular to the first and second insertion directions 6a, 6b and toward the lower contact plate 38. The plug contact 4 is thus pressed against the lower contact plate 38, in this case in particular against the contact spring arrangement 56 arranged on the contact body 44, which counteracts the force generated by the pressure spring elements 12. The plug contact 4 is thus securely held in the receptacle 2, and a solid electrical contact is established between the plug contact 4 and the contact body 44.

Of course, in other configurations, two or more plug contacts 4 may also be inserted into the receptacle 2. In particular, the two or more plug contacts 4 may be stacked one above the other in a direction perpendicular to the first and second insertion directions 6a, 6b. Of course, in some configurations, no contact body 44 may be provided, either alternatively or cumulatively.

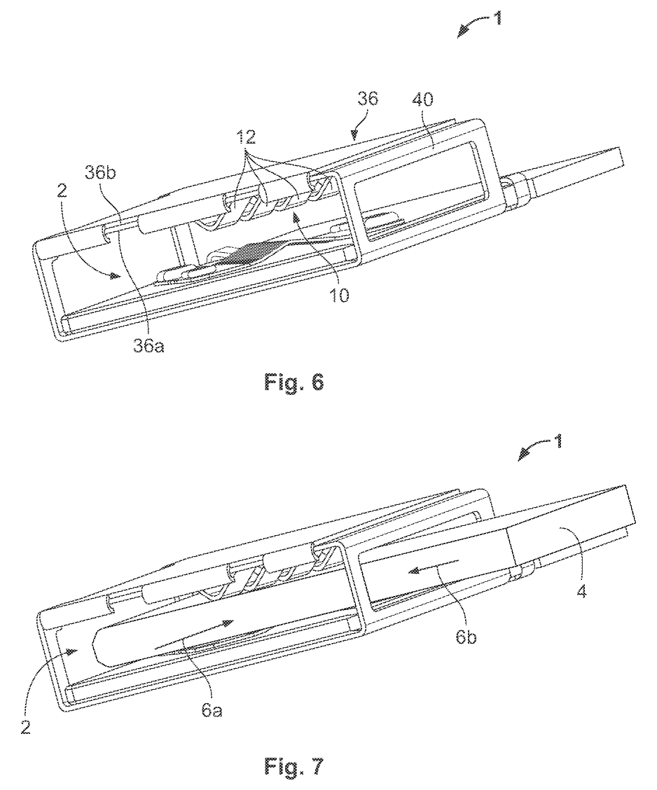

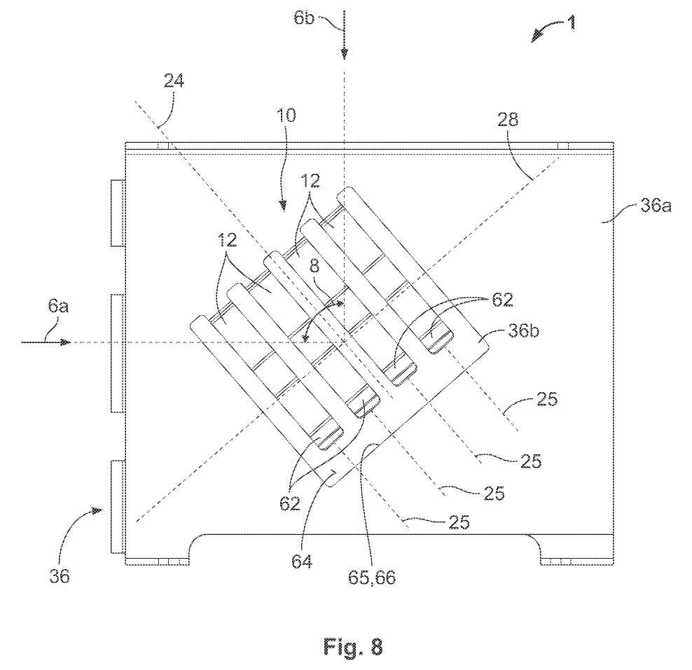

In the following, a further configuration of contact arrangement 1 is described with reference to FIGS. 6 to 8, focusing primarily on the differences from the configuration of contact arrangement 1 shown in FIGS. 1 to 5.

The contact arrangement 1 shown in FIGS. 6 to 8 also comprises the pressure spring arrangement 10 with several parallel pressure spring elements 12, which is arranged at least in part in the receptacle 2. However, the pressure spring elements 12, in particular their longitudinal directions 25, do not run perpendicular to the angle bisector 24 of the opening angle 8 between the first and second insertion directions 6a, 6b, but rather along the angle bisector 24 of the opening angle 8. Of course, even in this configuration, the pressure spring elements 12 do not have to extend exactly along the angle bisector 24, but may have a deviation 26 (not shown in FIGS. 6–8) of at most 15° from the angle bisector 24. Of course, the pressure spring elements 12 of the configuration shown in FIGS. 6 through 8 may however – with or without deviation 26 – extend along the perpendicular 28 to the angle bisector 24.

In contrast to the embodiment shown in FIGS. 1 to 5, the upper contact plate 36 of the contact arrangement 1 shown in FIGS. 6 to 8 has, purely by way of example, two layers. In particular, it may comprise an inner sub-plate 36a and an outer sub-plate 36bresting flatly on the inner sub-plate 36a, each of which may be formed from a sheet of metal. The inner and outer sub-plates 36a, 36b may be part of the contact cage 40, which surrounds the receptacle 2 at least in part. In the present embodiment, the contact cage 40 may be monolithically formed and, in particular, may be a stamped and bent part.

In the present embodiment, the pressure spring arrangement 10 may be formed monolithically with the inner sub-plate 36a of the upper contact plate 36. Each pressure spring element 12 may have a free end 62 that is displaceable along the outer sub-plate 36b of the upper contact plate 36, in particular on a side 64 of the outer sub-plate 36b facing the receptacle 2. For example, during insertion of the plug contact 4 into the receptacle 2, i.e., when the pressure spring elements 12 are compressed, the ends 62 of the pressure spring elements 12 can slide along the outer side plate 36b. A displacement of the ends 62 of the pressure spring elements may be limited in this process, in particular in the direction of the longitudinal directions 25 of the pressure spring elements 12, by a stop 65. In the present embodiment, the stop 65 is formed, purely by way of example, by an edge 66 of the inner sub-plate 36a of the upper contact plate 36.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, in the following claims, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A contact arrangement into which at least one plug contact, in particular a flat contact, can be inserted in at least two insertion directions, wherein the contact arrangement comprises:
a receptacle into which the at least one plug contact can be inserted along a first insertion direction and along a second insertion direction, wherein the first insertion direction and the second insertion direction enclose an opening angle,
a pressure spring arrangement arranged at least in part in the receptacle and comprising at least one pressure spring element, wherein the pressure spring arrangement is configured to press the at least one plug contact in a direction perpendicular to the first and second insertion directions,
wherein each pressure spring element extends with a deviation of at most 15° along or perpendicular to the angle bisector of the opening angle.

2. The contact arrangement according to claim 1, wherein the opening angle is between 0° and 180°.

3. The contact arrangement according to claim 1, wherein the at least one plug contact can be inserted into the receptacle along a third insertion direction opposite to the first insertion direction and along a fourth insertion direction opposite to the second insertion direction.

4. The contact arrangement according to claim 1, wherein at least one pressure spring element of the pressure spring arrangement is symmetrical with respect to a plane of symmetry spanned by the angle bisector of the opening angle and a normal to the first and second insertion directions.

5. The contact arrangement according to claim 1, wherein the contact arrangement comprises a contact spring arrangement having at least one contact spring element, which contact spring arrangement counteracts the pressure spring arrangement and is arranged at least in part within the receptacle.

6. The contact arrangement according to claim 5, wherein each contact spring element extends with a deviation of at most 15° along or perpendicular to the angle bisector of the opening angle.

7. The contact arrangement according to claim 5, wherein the pressure spring arrangement and the contact spring arrangement are configured identically.

8. The contact arrangement according to claim 1, wherein the pressure spring arrangement and/or the contact spring arrangement is or are a lamellar spring.

9. The contact arrangement according to claim 1, wherein the contact arrangement comprises an upper contact plate and a lower contact plate opposite the upper contact plate, and wherein the pressure spring arrangement is arranged on or formed by the upper contact plate and/or the contact spring arrangement is arranged on or formed by the lower contact plate.

10. The contact arrangement according to claim 9, wherein the lower contact plate and/or the upper contact plate comprises or comprise an inner sub-plate and an outer sub-plate abutting the inner sub-plate.

11. The contact arrangement according to claim 10, wherein the pressure spring arrangement is formed by or arranged on the inner or outer sub-plate of the upper contact plate, and/or the contact spring arrangement is formed by or arranged on the inner or outer sub-plate of the lower contact plate.

12. The contact arrangement according to claim 10, wherein at least one end of at least one pressure spring element of the pressure spring arrangement is displaceable along the outer sub-plate of the upper contact plate of the contact arrangement.

13. The contact arrangement according to claim 10, wherein the lower and/or upper contact plate is formed at least in part by a contact body that is removably received in the receptacle.

14. The contact arrangement according to claim 13, comprising a fastening and/or guide device that is configured to guide the contact body during insertion into and removal from the receptacle and/or to secure the contact body in the receptacle.

15. A kit comprising:
at least one plug contact having a corresponding contact body; and
a contact arrangement into which the at least one plug contact can be inserted in at least two insertion directions, the contact arrangement including a receptacle into which the contact body of the at least one plug contact can be inserted along a first insertion direction and along a second insertion direction, wherein the first insertion direction and the second insertion direction enclose an opening angle, the contact arrangement including a pressure spring arrangement arranged at least in part in the receptacle and comprising at least one pressure spring element, wherein the pressure spring arrangement is configured to press the at least one plug contact in a direction perpendicular to the first and second insertion directions, wherein each pressure spring element extends with a deviation of at most 15° along or perpendicular to the angle bisector of the opening angle.

16. The kit of claim 15, wherein the opening angle is between 0° and 180°.

17. The kit of claim 15, wherein the at least one plug contact can be inserted into the receptacle along a third insertion direction opposite to the first insertion direction and along a fourth insertion direction opposite to the second insertion direction.

18. The kit of claim 15, wherein at least one pressure spring element of the pressure spring arrangement is symmetrical with respect to a plane of symmetry spanned by the angle bisector of the opening angle and a normal to the first and second insertion directions.

19. The kit of claim 15, wherein the contact arrangement comprises a contact spring arrangement having at least one contact spring element, which contact spring arrangement counteracts the pressure spring arrangement and is arranged at least in part within the receptacle.

20. The kit of claim 15, wherein the contact arrangement comprises an upper contact plate and a lower contact plate opposite the upper contact plate, and wherein the pressure spring arrangement is arranged on or formed by the upper contact plate and/or the contact spring arrangement is arranged on or formed by the lower contact plate, wherein the lower contact plate and/or the upper contact plate comprises or comprise an inner sub-plate and an outer sub-plate abutting the inner sub-plate.
